(19) United States
(12) Patent Application Publication
(10) Pub. No.: US 2014/0014415 A1
(43) Pub. Date: Jan. 16, 2014

(54) WEIGHING DEVICE WITH A PRE-STRESSED CONCRETE DECK AND METHOD OF MAKING THE SAME

(71) Applicant: Matt Stovern, Webb City, MO (US)

(72) Inventor: Matt Stovern, Webb City, MO (US)

(73) Assignee: CARDINAL SCALE MANUFACTURING CO., Webb City, MO (US)

(21) Appl. No.: 13/548,747

(22) Filed: Jul. 13, 2012

(51) Int. Cl. G01G 19/02; B28B 5/00; G01G 21/23

(52) U.S. Cl. 177/133; 248/679; 264/219

(57) ABSTRACT

A weighing device comprises a plurality of weight sensors and at least one concrete deck. The weight sensors may be configured to determine a weight of an object. The concrete deck may be positioned on the weight sensors and may include a body, a first bulkhead, a second bulkhead, and a plurality of cables. The body may be formed from concrete. The first bulkhead may be positioned along a first end of the body. The second bulkhead may be positioned along an opposing second end of the body. The cables may be under tension and positioned within the body such that an outer surface of each cable is in direct contact with the concrete.

### BACKGROUND OF THE INVENTION

1. Field of the Invention

Embodiments of the current invention relate to weighing devices that include concrete decks as a load bearing surface.

2. Description of the Related Art

Weighing devices that include a deck are frequently utilized to weigh heavy loads. Examples of such loads include large vehicles, such as tractor trailers or military vehicles, livestock, such as cattle or horses, or the like. A typical weighing device includes at least one deck or module and a plurality of weight sensors. The deck provides a platform onto which vehicles are driven or animals are placed in order to be weighed. The weight sensors are positioned underneath the deck and measure the weight of the load. Often, the weight sensors transmit the weight to a station for recording.

The deck may be formed from concrete and generally includes a plurality of cables longitudinally positioned within the concrete body. The cables are usually jacketed inside a semi-rigid tube. After the concrete hardens, the cables are placed under high tension and anchored at bulkheads at the opposing ends of the concrete deck. Thus, the cables apply a large amount of pressure against the bulkheads, resulting in nonuniform compression of the concrete. Furthermore, the tensioning process of the cables is time and labor intensive.

### SUMMARY OF THE INVENTION

Embodiments of the current invention provide weighing devices that include concrete decks and methods of forming concrete decks that simplify the tensioning process.

Various embodiments of the current invention provide a weighing device broadly comprising a plurality of weight sensors and at least one concrete deck. The weight sensors may be configured to determine a weight of an object. The concrete deck may be positioned on the weight sensors and may include a body, a first bulkhead, a second bulkhead, and a plurality of cables. The body may be formed from concrete. The first bulkhead may be positioned along a first end of the body. The second bulkhead may be positioned along an opposing second end of the body. The cables may be under tension and positioned within the body such that an outer surface of each cable is in direct contact with the concrete.

Other embodiments of the current invention provide a concrete deck broadly comprising a body, a first bulkhead, a second bulkhead, and a plurality of cables. The body may be formed from concrete The first bulkhead may be positioned along a first end of the body. The second bulkhead may be positioned along an opposing second end of the body. The cables may be under tension and positioned within the body such that an outer surface of each cable is in direct contact with the concrete.

Other embodiments of the current invention provide a method for forming a concrete deck for use with a weighing device that broadly comprises the steps of: forming a mold with two bulkheads opposing one another, two siderails positioned therebetween, and a bottom pan at the lower edge of the siderails and the bulkheads; placing a plurality of cables through holes in the bulkheads; connecting one end of each cable to a restraint; connecting the other end of each cable to a tensioning device; increasing the tension in the cables; pouring concrete in the mold directly onto the cables; and cutting each cable flush with the bulkheads after the concrete has hardened.

Still other embodiments of the current invention provide a method for forming a plurality of concrete decks that broadly comprises the steps of: forming a plurality of molds, each mold including two bulkheads opposing one another, two siderails positioned therebetween, and a bottom pan at the lower edge of the siderails and the bulkheads; placing the molds next to one another such that the siderails of the molds are aligned and there is a space between the bulkheads; placing a plurality of cables through holes in the bulkheads such that each cable extends through all of the molds; connecting one end of each cable to a restraint; connecting the other end of each cable to a tensioning device; increasing the tension in the cables; pouring concrete in each mold directly onto the cables; and cutting each cable flush with the bulkheads of each concrete deck after the concrete has hardened.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a perspective view of a weighing device, constructed in accordance with various embodiments of the current invention, depicting the weighing device in operation weighing a vehicle;

FIG. 2 is a perspective view of the weighing device depicting two concrete decks shown in dashed line and a plurality of weight sensors;

FIG. 3 is a perspective view of a concrete deck depicting a concrete body and a bulkhead;

FIG. 4 is a fragmentary perspective view of a corner of the concrete deck with a portion of the concrete and the bulkhead removed, exposing a plurality of cables and a plurality of rebar rods;

FIG. 5 is a perspective view of a mold used to form the concrete deck;

FIG. 6 is a perspective view of a system used to form the concrete deck, the system including a plurality of restraints and a plurality of tensioning devices;

FIG. 7 is a perspective view of the concrete with the cables extending from the bulkheads before the cables are cut;

FIG. 8 is a top view of a system used to form a plurality of concrete decks, the system including a plurality of molds;

FIG. 9 is a flow diagram of at least a portion of the steps of a method to form a concrete deck; and

FIG. 10 is a flow diagram of at least a portion of the steps of a method to form a plurality of concrete decks.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

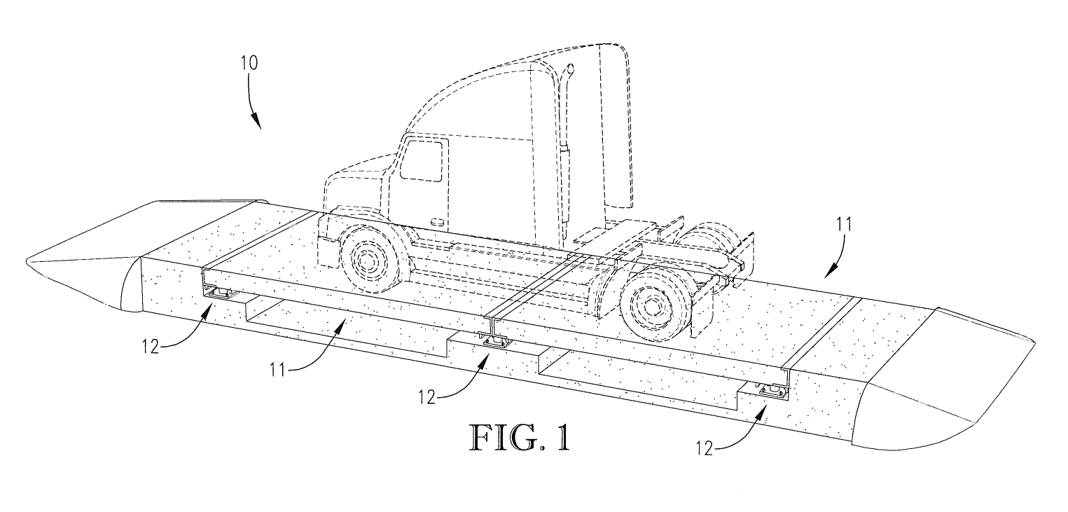

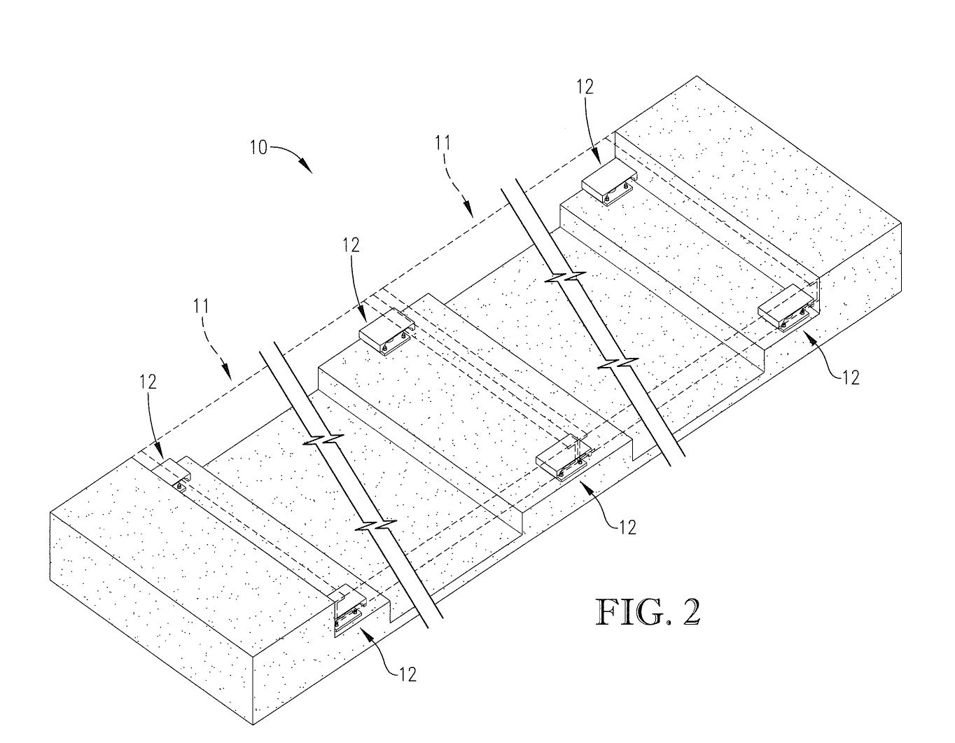

A weighing device 10, constructed in accordance with various embodiments of the current invention, is shown in FIGS. 1-2 and broadly comprises at least one concrete deck 11 and a plurality of weight sensors 12. The weighing device 10 may be a large load vehicle scale, such as a truck scale, that is utilized to weigh tractor trailers, military vehicles, or the like. The weighing device 10 may also be utilized to weigh livestock or generally heavy loads.

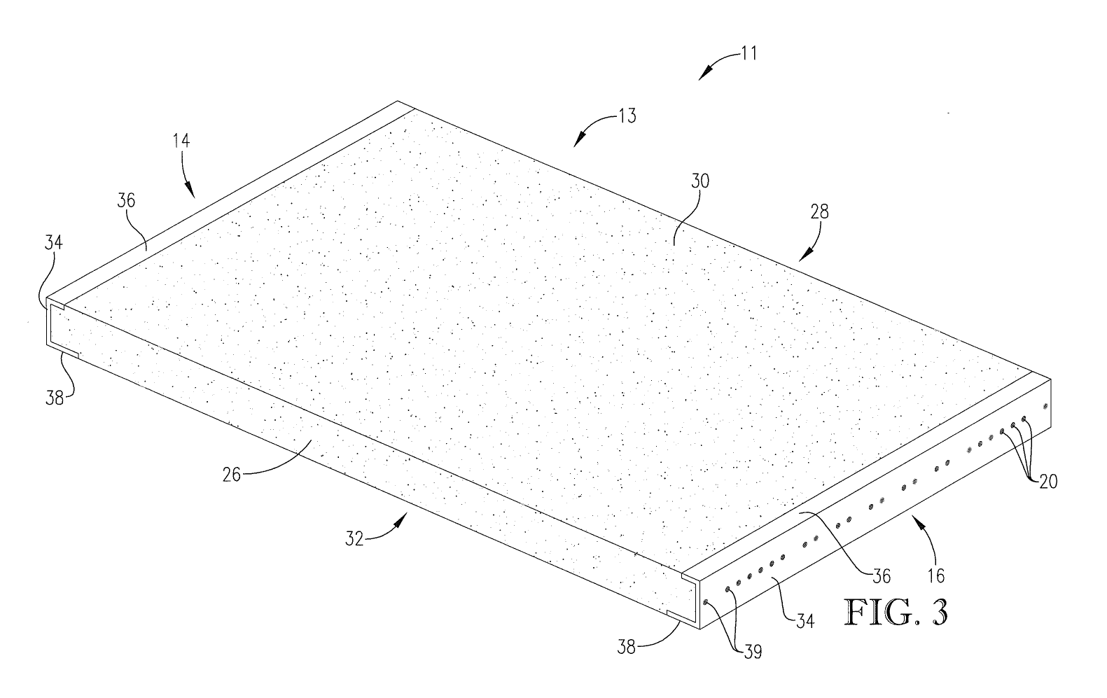

The concrete deck 11, as shown in FIGS. 3-4 and 7-8, may include a body 13, a first bulkhead 14, a second bulkhead 16, a plurality of rebar rods 18, and a plurality of cables 20.

The body 13 generally has an elongated box or slab shape and includes six sides with first and second ends, a first sidewall 26, an opposing second sidewall 28, a top wall 30, and an opposing bottom wall 32. When the concrete deck is in use, the top wall 30 may be the surface onto which vehicles are driven or loads are placed in order to be weighed, while the bottom wall 32 may contact or couple with the weight sensors 12.

The body 13 is generally formed from concrete, as described in greater detail below. The concrete may include aggregate and cement mixed with water. In various embodiments, the aggregate may include expanded shale and/or sand which is dried in a rotary kiln, or similar device, to reduce its density. An exemplary aggregate has a density of less than approximately 70 pounds per cubic foot.

The first bulkhead 14 and the second bulkhead 16 may be substantially identical and may serve as end caps or plates for the concrete deck 11. The first bulkhead 14 may be positioned along the first end of the body 13, and the second bulkhead 16 may be positioned along the second end of the body 13. The first and second bulkheads 14, 16 may each include a first wall 34, an upper ledge 36, and a lower ledge 38. The upper ledge 36 and the lower ledge 38 may extend at roughly a right angle from the top and bottom sides of the first wall 34. The first and second bulkheads 14, 16 may be formed from materials such as metals. In addition, the first bulkhead 14 and the second bulkhead 16 may include a plurality of holes 39 positioned in a single line lengthwise and spaced apart. The holes 39 may have a diameter of approximately the same diameter as the cables 20.

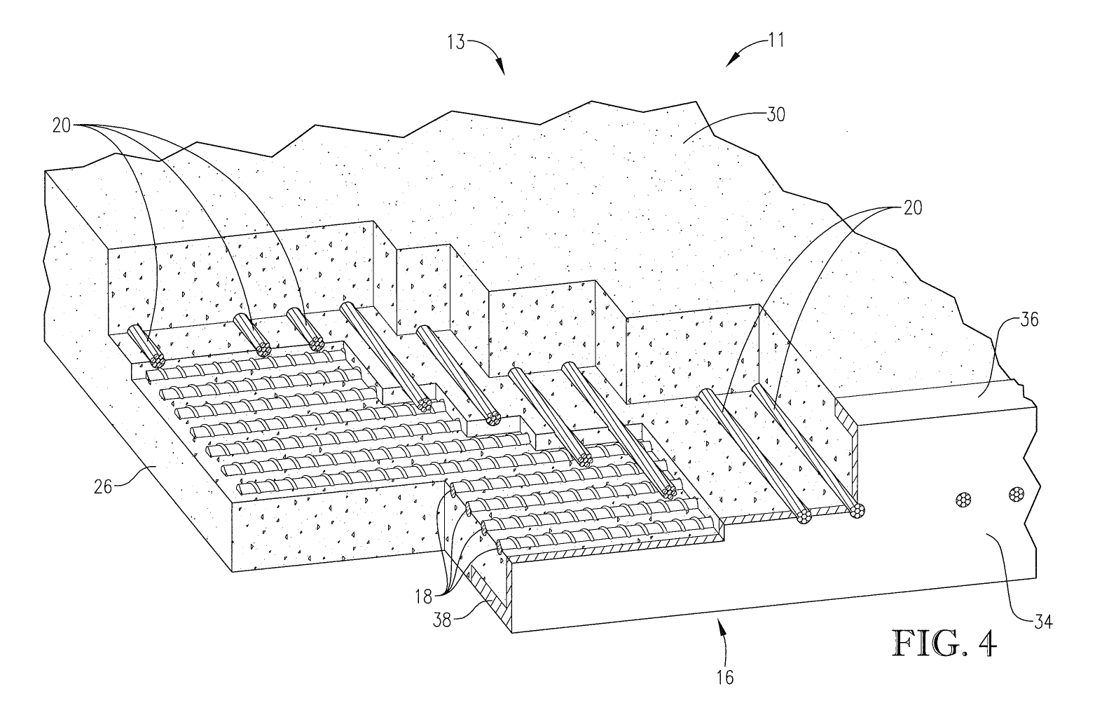

The rebar rods 18, as best seen in FIG. 4, may be reinforcement bar rods as are commonly known and used. Generally, the rebar rods 18 are positioned parallel to one another in the transverse or lateral direction within the body 13 of the concrete deck 11.

The cables 20, as best seen in FIG. 4, may include cables of metal as are commonly known and used. Typically, the cables 20 are stranded and twisted. Furthermore, the cables 20 may be under tension. The outer surface of each cable 20 may be in direct contact with or covered by the concrete of the body 13. The cables 20 may be positioned parallel to one another along the longitudinal axis within the body 13. In some embodiments, the rebar rods 18 are positioned below the cables 20 within the body 13. In such embodiments, the concrete deck 11 may further include a plurality of ties that suspend the rebar rods 18 from the cables 20, such that each tie ties one rebar rod 18 to one cable 20. Given the grid-like structure of the cables 20 and the rebar rods 18, each rebar rod 18 may be suspended from a plurality of cables 20 and each cable 20 may support a plurality of rebar rods 18. The ends of each cable 20 may align roughly with or be flush with the first and second bulkheads 14, 16.

The weight sensors 12 generally determine the weight of the load and may include conventional devices such as load cells, pressure sensors, transducers, strain gauges, or the like, or combinations thereof. The weight sensors 12 may generate a pressure signal, an electrical signal, or electronic data that represents the determined weight. The weight sensors 12 may transmit the determined weight to an external system, such as a weigh station either nearby or remote, through wires or cables, or wirelessly using conventional radio frequency (RF) transceiving components.

The weighing device 10 may function as follows. One or more concrete decks 11 may be placed on or otherwise integrated with a plurality of weight sensors 12. Typically, the weight sensors 12 are positioned on a support structure that is embedded in the ground. The concrete decks 11 may be positioned end to end such that the second bulkhead 16 of one concrete deck 11 is adjacent to the first bulkhead 14 of another concrete deck 11. An example of the weighing device 10 with two concrete decks 11 placed end to end is shown in FIGS. 1 and 2. During operation of the weighing device 10 as a vehicle scale, shown in FIG. 1, a vehicle (shown in dashed line) drives onto the concrete decks 11 and the weight sensors 12 report the weight of the vehicle to a station.

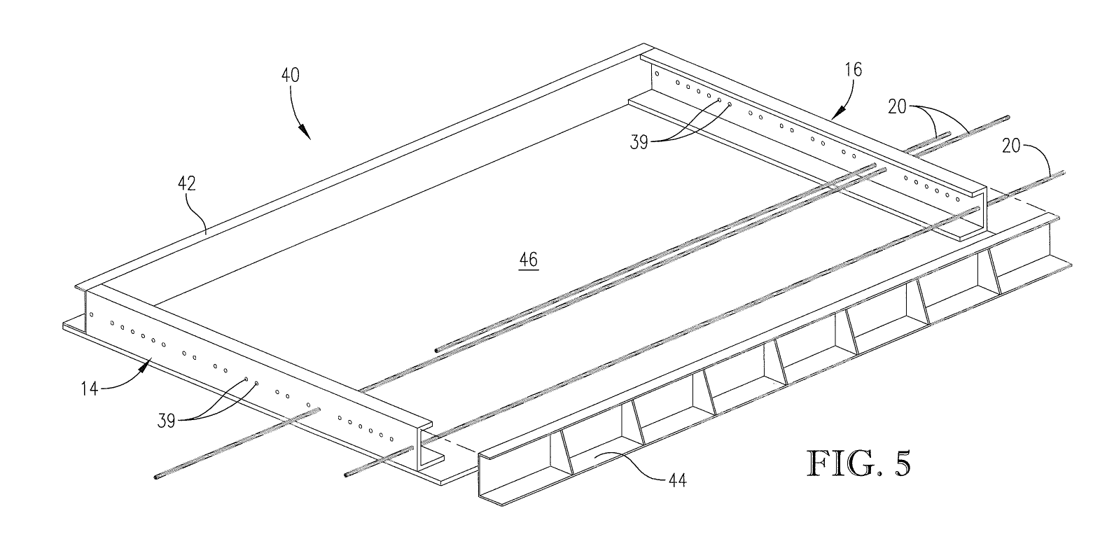

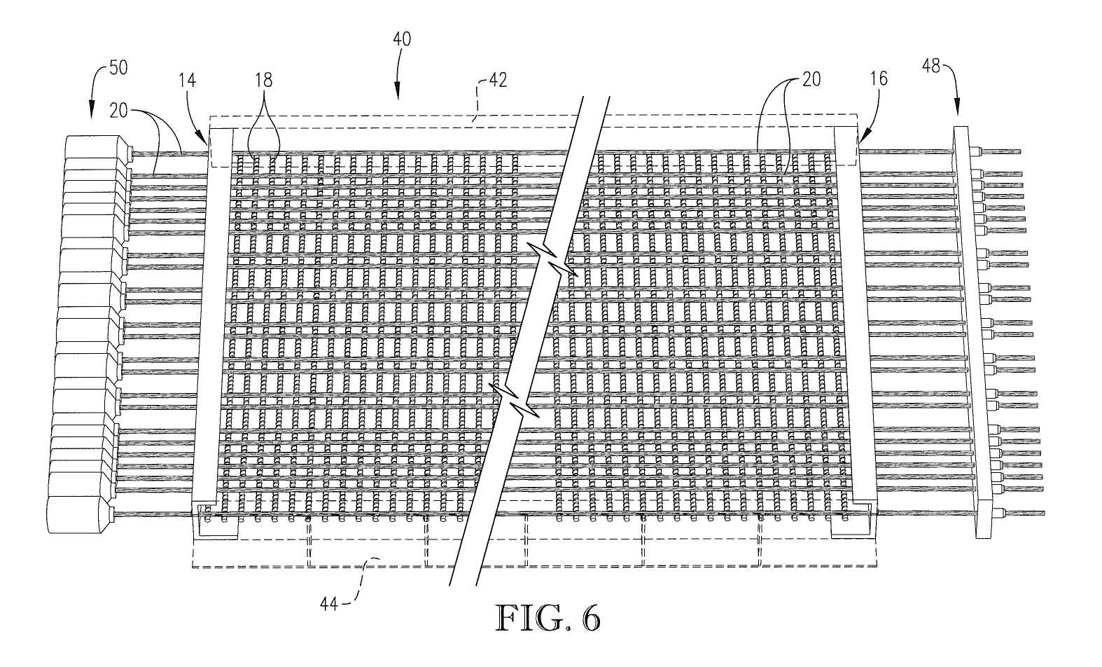

The concrete deck 11 may be formed in a single concrete deck 11 process as follows. A mold 40 for the concrete deck 11 may by created, as shown in FIGS. 5-6. The mold 40 may include a first siderail 42, a second siderail 44, and a bottom pan 46. The first siderail 42 may have at least the same dimensions as the first sidewall 26. The second siderail 44 may have at least the same dimensions as the second sidewall 28. The bottom pan 46 may have at least the dimensions as the bottom wall 32. The first siderail 42 and the second siderail 44 may be positioned upright along opposing sides (typically the longer sides) of the bottom pan 46, such that the lower edges of the siderails 42, 44 are in contact with the side edges of the bottom pan 46. The first bulkhead 14 and the second bulkhead 16 may be positioned upright at opposing ends of the bottom pan 46. The holes 39 of the first bulkhead 14 should roughly align with the holes 39 of the second bulkhead 16. The lower ledges 38 of the bulkheads 14, 16 may align with and contact the ends of the bottom pan 46. Thus, the four sides and the bottom of the mold 40 are set.

The cables 20 may be placed through the holes 39 of the first and second bulkheads 14, 16. At this point, each cable 20 may be longer than the length of the mold 40, such that each cable 20 may extend beyond the first and second bulkheads 14, 16 by a couple of feet. One end of each cable 20, for example, the end near the second bulkhead 16, may be rigidly attached to a restraint 48 positioned a short distance from the second bulkhead 16. The restraint 48 may include a beam or other rigidly held structure with a hole for each cable 20, wherein each cable 20 is fastened to the beam with a clamping collet. The other end of each cable 20 may be held by a tensioning device 50, such as an electric, pneumatic, or hydraulic cylinder, or the like, positioned a short distance from the first bulkhead 14. Hence, there may be a plurality of tensioning devices 50. The rebar rods 18 may be positioned within the mold 40 transverse to the cables 20. Known techniques may be utilized to position the rebar rods 18 either above or below the cables 20. An exemplary method may include placing each rebar rod 18 underneath the cables 20 and tying the rods 18 to the cables 20 such that the rods 18 hang crosswise below the cables 20. In various embodiments, other components that will remain in the concrete deck 11, such as plates and the like, may be added and positioned within the mold 40. With the rebar rods 18 in place, the tension of the cables 20 may be increased by activating the tensioning devices 50 to pull on the cables 20.

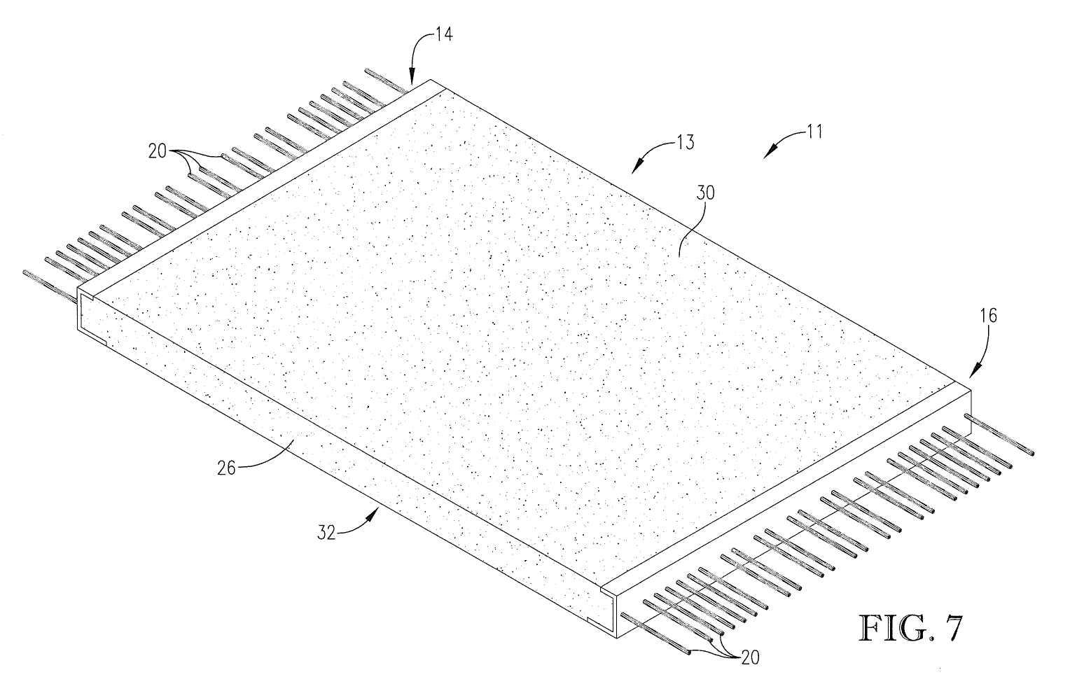

The aggregate of the concrete may include expanded shale and/or sand and may be dried in a rotary kiln or similar device. The aggregate may be mixed with the cement and water in a known fashion. The concrete may then be poured into the mold 40 and directly onto the cables 20 and the rebar rods 18. The cables 20 may be kept under high tension while the concrete sets and hardens. An exemplary time period for the concrete to harden is two weeks. After the concrete has hardened, the concrete deck 11 is formed, and the first and second siderails 42, 44 and the bottom pan 46 may be removed from the body 13. The concrete deck 11 with the cables 20 still extending from the bulkheads 14, 16 is shown in FIG. 7. Each cable 20 may be cut to be flush with the outer surface of the first bulkhead 14 and the second bulkhead 16. As each cable 20 tries to retract axially from the high tension being removed, each cable 20 tries to expand laterally or radially. The hardened concrete, which contacts the outer surface of each cable 20, prevents the cables 20 from expanding, thereby keeping the cables 20 in tension, which compresses the concrete and provides mechanical strength for the concrete deck 11. Prior art concrete decks may include cables that are placed inside tubes positioned within the concrete. The cables are placed under tension and then tied off with anchors that apply an inward, compressive force against the end bulkheads of the concrete deck. The architecture of the concrete deck 11 of the current invention, with the tensioned cables in direct contact with the concrete, provides a more uniform compression of the concrete than does the architecture of prior art concrete decks.

In order to increase production efficiency, the single concrete deck 11 process discussed above may be modified in a multiple concrete deck 11 process to form a plurality of concrete decks 11. A plurality of molds 40 may be created. The molds 40 may be placed end to end with the siderails 42, 44 of all the molds 40 in alignment. There may be a space between the bulkheads 14, 16 of adjacent molds 40. The cables 20 may be placed through the holes 39 of all the bulkheads 14, 16, such that each cable 20 extends through all of the molds 40. One end of each cable 20 may be tied to a restraint 48. The other end of each cable 20 may be held by a tensioning device 50. Rebar rods 18 may be added to each mold 40 transverse to the cables 20. The tension of the cables 20 may be increased by activating the tensioning devices 50 to pull on the cables 20.

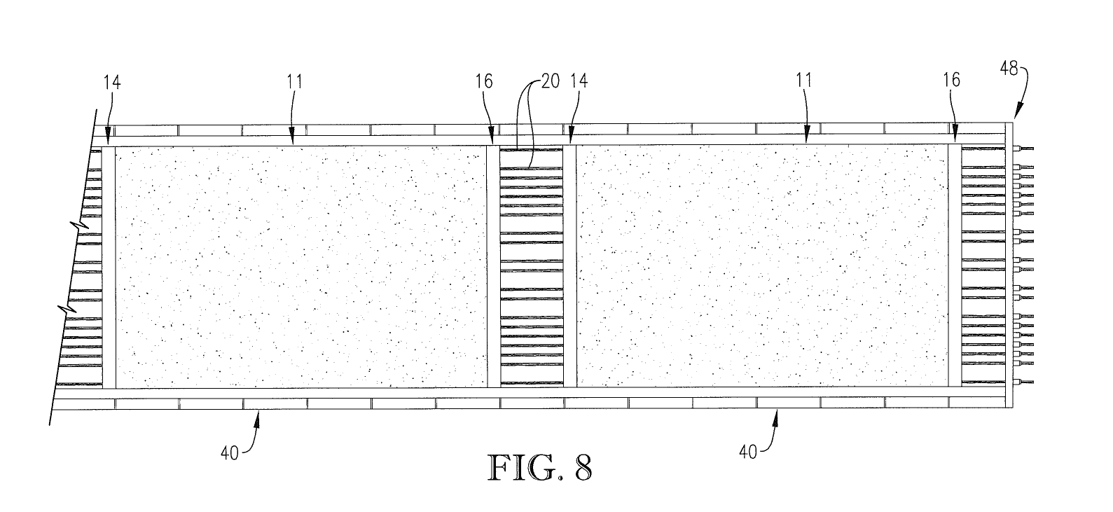

Concrete, as described above, may then be poured into each mold 40 and directly onto the cables 20 and the rebar rods 18 therein. The cables 20 may be kept under high tension while the concrete sets and hardens, as shown in FIG. 8. After the concrete has hardened, the concrete decks 11 are formed, and the first and second siderails 42, 44 and the bottom pan 46 may be removed from the body 13 of each deck 11. The cables 20 may be cut flush with the bulkheads 14, 16 on each concrete deck 11.

The tensioning process, which includes restraining each cable 20 and applying a pulling force thereto, may be time, labor, and material intensive. Since the same cables 20 are positioned in a plurality of concrete decks 11, the tensioning step of the multiple concrete deck 11 process needs to be performed only once in order to create all of the decks 11. Whereas with other approaches, the tensioning process has to be performed for each concrete deck 11 separately, thereby costing additional time, labor, and materials.

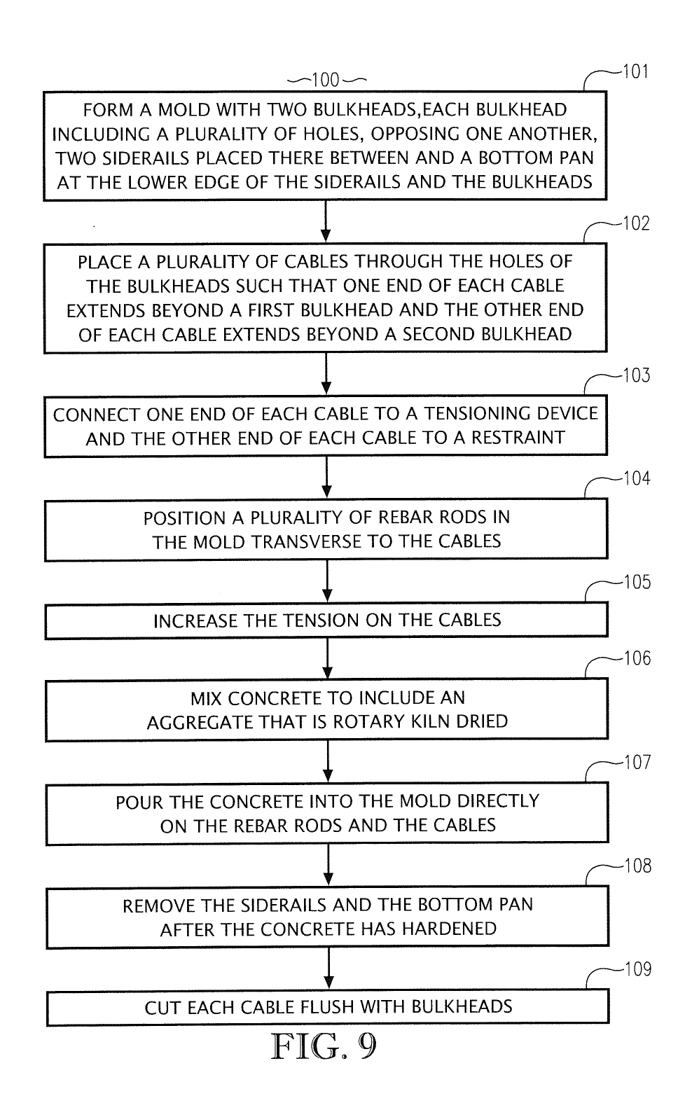

At least a portion of the steps of a method 100 for forming a concrete deck 11, in accordance with various embodiments of the present invention, are shown in FIG. 9. The steps of the method 100 may be performed in the order as shown in FIG. 9, or they may be performed in a different order. Furthermore, some steps may be performed concurrently as opposed to sequentially. In addition, some steps may not be performed and/or other steps may be added.

In connection with step 101, a mold 40 is formed with two bulkheads 14, 16 opposing one another, two siderails 42, 44 placed therebetween, and a bottom pan 46 positioned at the lower edge of the siderails 42, 44 and the bulkheads 14, 16, as shown in FIG. 5. Each bulkhead 14, 16 may include a plurality of holes 39 positioned in a single line lengthwise and evenly spaced apart. Each bulkhead 14, 16 may also include an upper ledge 36 and a spaced apart lower ledge 38. The lower ledges 38 of the bulkheads 14, 16 may align with and contact the ends of the bottom pan 46.

In connection with step 102, a plurality of cables 20 is placed through the holes 39 of the bulkheads 14, 16. One cable 20 may be placed through each pair of holes 39 in the bulkheads 14, 16 that are aligned. Furthermore, one end of each cable 20 may extend beyond a first bulkhead 14, while the other end extends beyond a second bulkhead 16.

In connection with step 103, one end of each cable 20 is connected to a tensioning device 50 and the other end of each cable 20 is connected to a restraint 48, as shown in FIG. 6.

In connection with step 104, a plurality of rebar rods 18 is placed in the mold 40 transverse to the cables 20. In some embodiments, the rebar rods 18 may be positioned underneath the cables 20 and then tied thereto, such that the rods 18 hang below the cables 20 crosswise.

In connection with step 105, the tension on the cables 20 is increased. The tensioning devices 50 may be activated to pull on the cables 20.

In connection with step 106, concrete is mixed to include an aggregate that is rotary kiln or similarly dried. The aggregate may include expanded shale and/or sand.

In connection with step 107, the concrete is poured into the mold 40 directly onto the cables 20 and the rebar rods 18.

In connection with step 108, the siderails 42, 44 and the bottom pan 46 are removed from the concrete deck 11 after the concrete has hardened. Tension in the cables 20 may be maintained while the concrete hardens.

In connection with step 109, each cable 20 is cut flush with the bulkheads 14, 16.

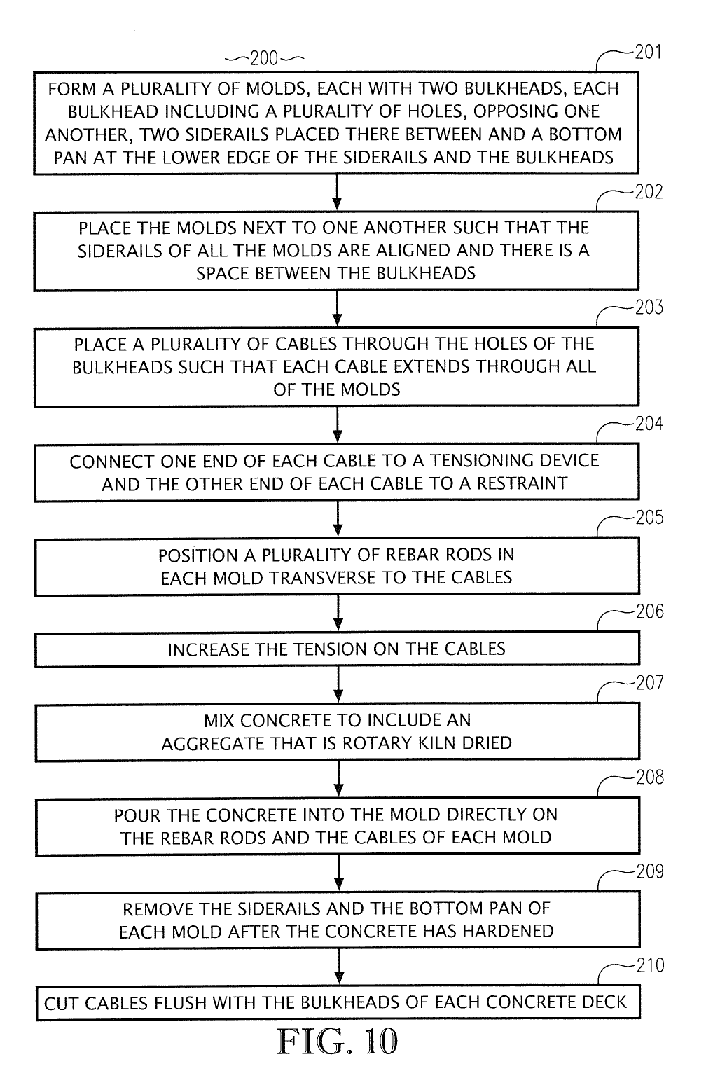

At least a portion of the steps of a method 200 for forming a plurality of concrete decks 11, in accordance with various embodiments of the present invention, are shown in FIG. 10. The steps of the method 200 may be performed in the order as shown in FIG. 10, or they may be performed in a different order. Furthermore, some steps may be performed concurrently as opposed to sequentially. In addition, some steps may not be performed and/or other steps may be added.

In connection with step 201, a plurality of molds 40 are formed, each with two bulkheads 14, 16 opposing one another, two siderails 42, 44 placed therebetween, and a bottom pan 46 positioned at the lower edge of the siderails 42, 44 and the bulkheads 14, 16. Each bulkhead 14, 16 may include a plurality of holes 39 positioned in a single line lengthwise and evenly spaced apart. Each bulkhead 14, 16 may also include an upper ledge 36 and a spaced apart lower ledge 38. The lower ledges 38 of the bulkheads 14, 16 may align with and contact the ends of the bottom pan 46.

In connection with step 202, the molds 40 are placed next to one another, or end to end, such that the siderails 42, 44 of all the molds 40 are aligned and there is a space between the bulkheads 14, 16, as shown in FIG. 8.

In connection with step 203, a plurality of cables 20 is placed through the holes 39 of the bulkheads 14, 16 such that each cable 20 extends through all of the molds 40. One cable 20 may be placed through each pair of holes 39 in the bulkheads 14, 16 that are aligned. Furthermore, one end of each cable 20 may extend beyond a first bulkhead 14 of an end mold 40, while the other end extends beyond a second bulkhead 16 of an end mold 40.

In connection with step 204, one end of each cable 20 is connected to a tensioning device 50 and the other end of each cable 20 is connected to a restraint 48.

In connection with step 205, a plurality of rebar rods 18 is placed in each mold 40 transverse to the cables 20. The rebar rods 18 may be positioned underneath the cables 20 and then tied thereto, such that the rods 18 hang below the cables 20 crosswise.

In connection with step 206, the tension on the cables 20 is increased. The tensioning devices 50 may be activated to pull on the cables 20.

In connection with step 207, concrete is mixed to include an aggregate that is rotary kiln or similarly dried. The aggregate may include expanded shale and/or sand.

In connection with step 208, the concrete is poured into each mold 40 directly onto the cables 20 and the rebar rods 18.

In connection with step 209, the siderails 42, 44 and the bottom pan 46 are removed from each concrete deck 11 after the concrete has hardened. Tension in the cables 20 may be maintained while the concrete hardens.

In connection with step 210, each cable 20 is cut flush with the bulkheads 14, 16 of each mold 40.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A weighing device comprising:
a plurality of weight sensors configured to determine a weight of an object; and
a concrete deck positioned on the weight sensors, the concrete deck including:
a body formed from concrete;
a first bulkhead positioned along a first end of the body;
a second bulkhead positioned along an opposing second end of the body; and
a plurality of cables that are under tension and positioned within the body such that an outer surface of each cable is in direct contact with concrete.

2. The weighing device of claim 1, wherein the concrete deck further includes a plurality of rebar rods positioned within the body transverse to the cables.

3. The weighing device of claim 1, wherein the concrete of the concrete deck further includes an aggregate formed from expanded shale and/or sand.

4. The weighing device of claim 1, wherein the concrete of the concrete deck further includes an aggregate with a density of less than 70 pounds per cubic inch.

5. The weighing device of claim 1, wherein each bulkhead includes an upper ledge that aligns with a top wall of the body and a spaced apart lower ledge that aligns with a bottom wall of the body.

6. The weighing device of claim 1, wherein the ends of each cable roughly align with the bulkheads.

7. A concrete deck for use with a weigh scale, the concrete deck comprising:
a body formed from concrete;
a first bulkhead positioned along a first end of the body;
a second bulkhead positioned along an opposing second end of the body; and
a plurality of cables that are under tension and positioned within the body such that an outer surface of each cable is in direct contact with concrete.

8. The concrete deck of claim 7, further comprising a plurality of rebar rods positioned within the body transverse to the cables.

9. The concrete deck of claim 7, wherein the concrete includes an aggregate that is rotary kiln dried.

10. The concrete deck of claim 7, wherein the concrete includes an aggregate formed from expanded shale and/or sand.

11. The concrete deck of claim 7, wherein the concrete includes an aggregate with a density of less than 70 pounds per cubic inch.

12. The concrete deck of claim 7, wherein each bulkhead includes an upper ledge that aligns with a top wall of the body and a spaced apart lower ledge that aligns with a bottom wall of the body.

13. The concrete deck of claim 7, wherein the ends of each cable roughly align with the bulkheads.

14. A method for forming a concrete deck for use with a weigh scale, the method comprising the steps of:
forming a mold with two bulkheads opposing one another, two siderails positioned therebetween, and a bottom pan at the lower edge of the siderails and the bulkheads;
placing a plurality of cables through holes in the bulkheads;
connecting one end of each cable to a restraint;
connecting the other end of each cable to a tensioning device;
increasing the tension in the cables; and
pouring concrete in the mold directly onto the cables.

15. The method of claim 14, further comprising the step of cutting each cable flush with the bulkheads after the concrete has hardened.

16. The method of claim 14, further comprising the step of placing a plurality of rebar rods in the mold transverse to the cables.

17. The method of claim 14, wherein the concrete includes an aggregate that is rotary kiln dried.

18. The method of claim 14, wherein the concrete includes an aggregate formed from expanded shale and/or sand.

19. The method of claim 14, wherein the concrete includes an aggregate with a density of less than 70 pounds per cubic inch.

20. A method for forming a plurality of concrete decks for use with a weigh scale, the method comprising the steps of:
forming a plurality of molds, each mold including two bulkheads opposing one another, two siderails positioned therebetween, and a bottom pan at the lower edge of the siderails and the bulkheads;
placing the molds next to one another such that the siderails of the molds are aligned and there is a space between the bulkheads;
placing a plurality of cables through holes in the bulkheads such that each cable extends through all of the molds;
connecting one end of each cable to a restraint;
connecting the other end of each cable to a tensioning device;
increasing the tension in the cables; and
pouring concrete in each mold directly onto the cables.

21. The method of claim 20, further comprising the step of cutting each cable flush with the bulkheads of each concrete deck after the concrete has hardened.

22. The method of claim 20, further comprising the step of placing a plurality of rebar rods in each mold transverse to the cables.

23. The method of claim 20, wherein the concrete includes an aggregate that is rotary kiln dried.

24. The method of claim 20, wherein the concrete includes an aggregate formed from expanded shale and/or sand.

25. The method of claim 20, wherein the concrete includes an aggregate with a density of less than 70 pounds per cubic inch.
